(19) United States
(12) Patent Application Publication
(10) Pub. No.: US 2025/0280086 A1
(43) Pub. Date: Sep. 4, 2025

(54) PRINTING APPARATUS

(71) Applicant: SEIKO EPSON CORPORATION, Tokyo (JP)

(72) Inventor: Kenji OSHIMA, TATSUNO-MACHI (JP)

(21) Appl. No.: 19/069,579

(22) Filed: Mar. 4, 2025

(30) Foreign Application Priority Data
Mar. 4, 2024 (JP) 2024-032303

(51) Int. Cl. H04N 1/00

(52) U.S. Cl. CPC H04N 1/00896; H04N 1/00708

(57) ABSTRACT

A printing apparatus includes a printing unit and a control unit. Apparatus states set by the control unit include a first operation mode and a second operation mode where power required for printing is supplied, and a sleep mode where power required for printing is not supplied, power consumption in the second operation mode is less than that in the first operation mode, and is more than that in the sleep mode, and the second operation mode is configured so that a method of setting power consumption is customized via a user interface.

The present application is based on, and claims priority from JP Application Serial Number 2024-032303, filed Mar. 4, 2024, the disclosure of which is hereby incorporated by reference herein in its entirety.

### BACKGROUND

### 1. Technical Field

The present disclosure relates to a printing apparatus that performs printing on a medium.

### 2. Related Art

JP-A-2011-048317 discloses an image formation apparatus in which a color image recording unit is set to a low power consumption mode during monochrome image recording.

The image formation apparatus described in JP-A-2011-048317 can perform recording a monochrome image while reducing power consumption by setting the color image recording unit to the low power consumption mode during monochrome image recording. However, contents of a mode for performing recording while reducing power consumption are fixed, and usability is not considered. In particular, for example, in the event of a disaster, a commercial power source may be unusable, and a small power generator or a portable battery is required. In some cases, sufficient power cannot be obtained. Furthermore, even in such a case, there may be a need to utilize the printing function as much as possible for information transmission, in other words, a need to achieve a balance between reducing power consumption and ensuring the printing function.

### SUMMARY

In order to solve the above-mentioned problem, a printing apparatus according to the present disclosure is a printing apparatus including a printing unit configured to perform printing on a medium, and a control unit configured to control the printing unit, wherein apparatus states set by the control unit include a first operation mode and a second operation mode being modes where power required for printing by the printing unit is supplied, and a sleep mode being a mode where power required for printing by the printing unit is not supplied, power consumption in the second operation mode is less than that in the first operation mode, and is more than that in the sleep mode, and the second operation mode is configured so that a method of setting power consumption is customized via a user interface.

### BRIEF DESCRIPTION OF THE DRAWINGS

FIG. 1 is a front view of a printing apparatus.

FIG. 2 is a block diagram illustrating a configuration of the printing apparatus.

FIG. 3 is a block diagram illustrating a configuration of a printing sensor group.

FIG. 4 is a block diagram illustrating a configuration of a scan sensor group.

FIG. 5 is a block diagram illustrating a configuration of an environment detection unit.

FIG. 6 is a block diagram illustrating a configuration of a communication IF group.

FIG. 7 is a flowchart illustrating a flow of a process after power-on.

FIG. 8 is a diagram illustrating a UI displayed on an operation panel.

FIG. 9 is a diagram illustrating the UI displayed on the operation panel.

FIG. 10 is a diagram illustrating the UI displayed on the operation panel.

FIG. 11 is a diagram illustrating the UI displayed on the operation panel.

FIG. 12 is a diagram illustrating the UI displayed on the operation panel.

FIG. 13 is a diagram illustrating the UI displayed on the operation panel.

FIG. 14 is a diagram illustrating the UI displayed on the operation panel.

### DESCRIPTION OF EMBODIMENTS

Hereinafter, the present disclosure is schematically described. A printing apparatus according to a first aspect is a printing apparatus including a printing unit configured to perform printing on a medium, and a control unit configured to control the printing unit, wherein apparatus states set by the control unit include a first operation mode and a second operation mode being modes where power required for printing by the printing unit is supplied, and a sleep mode being a mode where power required for printing by the printing unit is not supplied, power consumption in the second operation mode is less than that in the first operation mode, and is more than that in the sleep mode, and the second operation mode is configured so that a method of setting power consumption is customized via a user interface.

According to this embodiment, in the second operation mode, the method of setting power consumption can be customized via the user interface. Thus, printing can be performed according to a user need while suppressing power consumption, and usability is improved.

A second aspect being an aspect dependent on the first aspect includes a display unit configured to display various information, wherein monochrome display is selectable via the user interface as a display mode of the display unit in the second operation mode. According to this embodiment, monochrome display can be selected as a display mode of the display unit in the second operation mode. Thus, power consumption in the second operation mode can be reduced.

A third aspect being an aspect dependent on the first aspect includes a display unit configured to display various information, wherein reduction of a display region is selectable via the user interface as a display mode of the display unit in the second operation mode.

According to this embodiment, reduction of the display region can be selected as a display mode of the display unit in the second operation mode. Thus, power consumption in the second operation mode can be reduced. Note that it may be possible to apply this aspect not only to the first aspect described above but also to the second aspect described above.

A fourth aspect being an aspect dependent on the first aspect includes a display unit configured to display various information, wherein minimum brightness of the display unit at least during printing execution is selectable via the user interface as a display mode of the display unit in the second operation mode. According to this embodiment, minimum brightness of the display unit at least during printing execution can be selected as a display mode of the display unit in the second operation mode. Thus, power consumption in the second operation mode can be reduced more.

A fifth aspect being an aspect dependent on the first aspect includes a display unit configured to display various information, wherein light-off of the display unit at least during printing execution is selectable via the user interface as a display mode of the display unit in the second operation mode.

According to this embodiment, light-off of the display unit at least during printing execution can be selected as a display mode of the display unit in the second operation mode. Thus, power consumption in the second operation mode can be reduced. Note that it may be possible to apply this aspect not only to the first aspect described above but also to any one of the second to fourth aspects described above.

A sixth aspect being an aspect dependent on the first aspect includes a detection unit that detects an apparatus state change, wherein the control unit cancels the sleep mode when a signal of the detection unit is changed in the sleep mode, and cutting-off of power supply to the detection unit in the second operation mode is selectable via the user interface.

According to this embodiment, cutting-off of power supply to the detection unit in the second operation mode can be selected. Thus, power consumption in the second operation mode can be reduced. Note that it may be possible to apply this aspect not only to the first aspect described above but also to any one of the second to fifth aspects described above.

A seventh aspect being an aspect dependent on the first aspect includes a medium placement unit on which a medium before feeding is placed, and a medium size detection unit configured to detect a size of the medium placed on the medium placement unit, wherein cutting-off of power supply to the medium size detection unit in the second operation mode is selectable via the user interface.

According to this embodiment, cutting-off of power supply to the medium size detection unit in the second operation mode can be selected. Thus, power consumption in the second operation mode can be reduced. Note that it may be possible to apply this aspect not only to the first aspect described above but also to any one of the second to sixth aspects described above.

An eighth aspect being an aspect dependent on the first aspect includes an environment detection unit configured to detect an apparatus installation environment, wherein cutting-off of power supply to the environment detection unit in the second operation mode is selectable via the user interface.

According to this embodiment, cutting-off of power supply to the environment detection unit in the second operation mode can be selected. Thus, power consumption in the second operation mode can be reduced. Note that it may be possible to apply this aspect not only to the first aspect described above but also to any one of the second to seventh aspects described above.

A ninth aspect being an aspect dependent on the first aspect includes an environment detection unit configured to detect an apparatus installation environment, wherein the control unit executes transition to the second operation mode when a detection result of the environment detection unit exceeds a predetermined range.

When the detection result of the environment detection unit exceeds the predetermined range, it can be determined that an emergency such as a disaster occurs. According to this embodiment, the control unit executes transition to the second operation mode when the detection result of the environment detection unit exceeds the predetermined range. Thus, apparatus power consumption can be reduced appropriately when an emergency occurs, and usability is improved. Note that it may be possible to apply this aspect not only to the first aspect described above but also to any one of the second to eighth aspects described above.

In a tenth aspect being an aspect dependent on the first aspect, the control unit is configured to receive an earthquake early warning and execute transition to the second operation mode when the earthquake early warning is received.

According to this embodiment, the control unit can receive an earthquake early warning, and executes transition to the second operation mode when the earthquake early warning is received. Thus, apparatus power consumption can be reduced appropriately when an earthquake occurs, and usability is improved. Note that it may be possible to apply this aspect not only to the first aspect described above but also to any one of the second to ninth aspects described above.

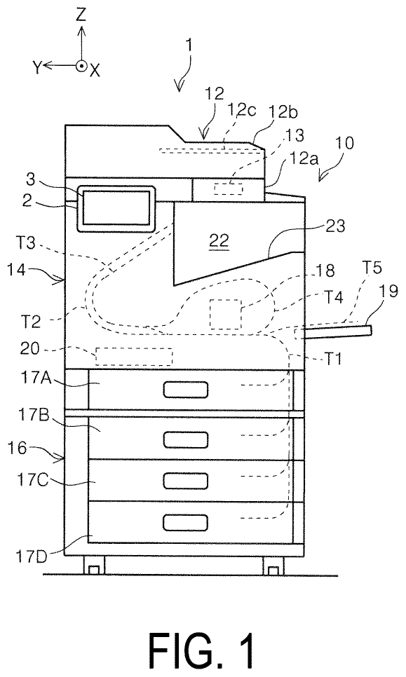

Hereinafter, the present disclosure is described in detail. Hereinafter, a printing apparatus 1 according to an embodiment of the present disclosure is described. In FIG. 1, an X-axis direction is a depth direction of the printing apparatus 1. A +X direction of the X-axis direction, which is a direction in which an arrow faces, is a direction from an apparatus rear surface toward an apparatus front surface, and a −X direction is a direction from the apparatus front surface toward the apparatus rear surface. Further, the X-axis direction is an example of a width direction of a medium. A Y-axis direction is an apparatus width direction of the printing apparatus 1, a +Y direction of the Y-axis direction, which is a direction in which an arrow faces, is a left direction as viewed from a user facing the apparatus front surface, and a −Y direction is a right direction. A Z-axis direction is an apparatus height direction of the printing apparatus 1, and is a vertical direction, a +Z direction, which is a direction in which an arrow faces, is a vertically upward direction, and a −Z direction is a vertically downward direction. In the following description, the +Z direction may be simply referred to as an upward direction, and the −Z direction may be simply referred to as a downward direction.

As illustrated in FIG. 1, the printing apparatus 1 includes a printing unit 10. The printing unit 10 according to the present embodiment is an ink jet printer that performs printing by ejecting ink, which is an example of a liquid, onto a medium exemplified by a printing sheet. The printing apparatus 1 includes a line head 18 being an example of a printing unit. Note that the term “printing” may be replaced with recording or image formation. Further, a scanner unit 12 being an example of an image reading device is provided to an upper portion of the printing unit 10. In other words, the printing apparatus 1 is a so-called multifunction printer, and a copy function, a scanner function, a facsimile function, and the like are achieved by using the scanner unit 12. However, the printing unit 10 is not limited to the ink jet printer, and may be configured to perform printing by another method, such as a laser printer, a thermal transfer printer, and a dot impact printer.

The printing unit 10 includes a main body unit 14, a medium accommodation unit 16 that accommodates a medium, a medium transport unit (omitted in illustration) that transports a medium, the line head 18, and an in-body discharge unit 22 to which a medium is discharged. Further, the printing unit 10 includes a control unit 20 that controls the entire printing apparatus 1 and an operation panel 2 functioning as a display unit that receives various setting operations and displays various information.

The medium accommodation unit 16 includes a first media cassette 17A, a second media cassette 17B, a third media cassette 17C, and a fourth media cassette 17D in the stated order from above. Those medium cassettes are examples of a medium placement unit on which a medium before feeding is placed. A transport path in which a medium is transported is provided inside the main body unit 14. The reference T1 denotes a feed path in which the medium sent from each medium cassette is fed to a position facing the line head 18, which is described later. Further, the reference T2 denotes a discharge path in which the medium after recording is discharged. Further, the reference T3 denotes a path for sending the medium when recording on both surfaces of the medium is performed, and is a switch-back path for switching back the medium. Further, the reference T4 denotes is a path to which the medium is sent from the switch-back path T3, and is an inversion path for inverting the medium. Further, the reference T5 denotes a supply path in which a medium from the medium supply tray 19 is supplied. The medium supply tray 19 is provided to the side surface of the printing unit 10 in the −Y direction in an openable/closable manner. The supply path T5 merges with the feed path T1. The medium supply tray 19 is an example of a medium placement unit on which a medium before feeding is placed.

The line head 18 includes a plurality of ink ejection nozzles (omitted in illustration) that are arranged corresponding to an entire region of the medium in the X-axis direction, in other words, the width direction. The line head 18 performs printing on the medium by ejecting ink supplied from an ink tank (omitted in illustration) from the plurality of ink ejection nozzles toward the medium. However, the ink ejection head serving as a printing unit may be a type that performs recording while moving in the width direction of the medium. The medium after printing is performed by the printing unit 10 is discharged to the in-body discharge unit 22 via the discharge path T2, and is stacked on an in-body discharge tray 23 provided to the in-body discharge unit 22.

The scanner unit 12 includes a scanner main body unit 12a and an automatic original sheet transport unit 12b. The automatic original sheet transport unit 12b rotates about a rotation shaft (omitted in illustration) with respect to the scanner main body unit 12a to open and close an original sheet table (omitted in illustration) that is provided to the scanner main body unit 12a. The scanner main body unit 12a includes a reading unit 13. The reading unit 13 is an image sensor that is provided to extend in the X-axis direction and is movable in the Y-axis direction. The automatic original sheet transport unit 12b includes an original sheet tray 12c on which an original sheet is placed, and an original sheet that is set on the original sheet tray 12c is transported to a reading position by transport means (omitted in illustration).

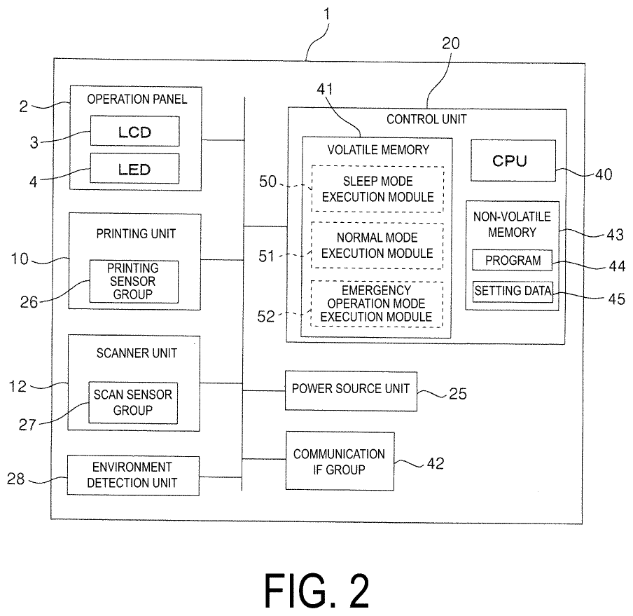

The control unit 20 controls the entire printing apparatus 1 including the line head 18, based on information that is input via the operation panel 2. As illustrated in FIG. 2, the control unit 20 includes a CPU 40, a volatile memory 41, and a non-volatile memory 43. The operation panel 2, the printing unit 10, the scanner unit 12, a power source unit 25, and a communication IF group 42 are electrically coupled to the control unit 20.

The CPU 40 loads a program 44 stored in the non-volatile memory 43 into the volatile memory 41, and executes the program 44. The program 44 includes various programs for controlling the printing unit 10, and includes programs for achieving respective operation modes described later. The control unit 20 executes the program 44 in the volatile memory 41 as a work area to achieve various functions including a sleep mode execution module 50, a normal mode execution module 51, and an emergency operation mode execution module 52. The sleep mode execution module 50 achieves the sleep mode described later. The normal mode execution module 51 achieves the normal mode described later. The emergency operation mode execution module 52 achieves the emergency operation mode described later.

Note that the various functions may be achieved not only by the software processes. For example, the various functions may be achieved by a dedicated hardware circuit, for example, an application-specific integrated circuit (ASIC). Further, the non-volatile memory 43 stores setting data 45 received as an input via the operation panel 2. The setting data 45 includes information that is set via various user interfaces described later. In view of the above functions, the control unit 20 can also be referred to as an information processing device or a computer.

The operation panel 2 includes an LCD 3 and an LED 4. Under control of the control unit 20, the LED 4 can perform light-on and light-off. In a case of light-on, an illumination region can be limited, or an amount of emitted light can be adjusted. The LCD 3 functions as a so-called touch panel, and thus also functions as a part of an operation reception unit for receiving an operation from a user. Under control of the control unit 20, a user interface is achieved on the LCD 3. Hereinafter, the term “user interface” is described as a “UI”) for the sake of convenience. The program 44 includes a program for achieving various UIs. Hereinafter, when a process and an operation of the printing apparatus 1 are described based on the various UIs, it is assumed that the process and the operation are achieved by executing the program 44 by the control unit 20.

Under control of the control unit 20, the power source unit 25 supplies power required for each constituent component of the printing apparatus 1.

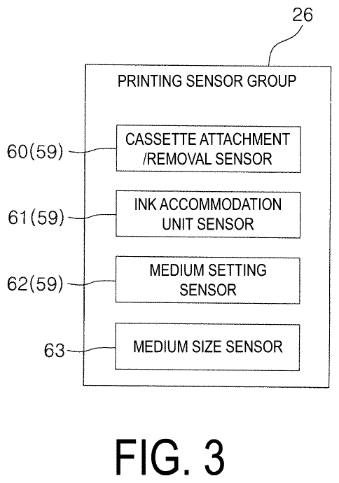

The printing unit 10 includes a printing sensor group 26. As illustrated in FIG. 3, the printing sensor group 26 includes a cassette attachment/removal sensor 60, an ink accommodation unit sensor 61, a medium setting sensor 62, and the medium size sensor 63. The cassette attachment/removal sensor 60 is provided individually to the first media cassette 17A, the second media cassette 17B, the third media cassette 17C, and the fourth media cassette 17D. The control unit 20 can detect whether each medium cassette is removed or attached, based on the detection information from the cassette attachment/removal sensor 60.

The ink accommodation unit sensor 61 detects an opening/closing state of a cover (omitted in illustration) that opens and closes an ink accommodation unit (omitted in illustration). The control unit 20 can detect whether the cover described above is opened or closed, based on the detection information from the ink accommodation unit sensor 61. The medium setting sensor 62 detects that a medium is set on the medium supply tray 19. The control unit 20 can detect whether a medium is set on the medium supply tray 19, based on the detection information from the medium setting sensor 62.

The medium size sensor 63 is provided individually to the first media cassette 17A, the second media cassette 17B, the third media cassette 17C, the fourth media cassette 17D, and the medium supply tray 19. The control unit 20 can detect a size of a medium that is set in each medium cassette or on the medium supply tray 19, based on the detection information from the medium size sensor 63. Note that the printing sensor group 26 may include other sensors other than those sensors, or one or more of the sensors illustrated in FIG. 3 may not be included. Note that, in the printing sensor group 26, the cassette attachment/removal sensor 60, the ink accommodation unit sensor 61, and the medium setting sensor 62 are examples of detection means 59 for detecting an apparatus state change.

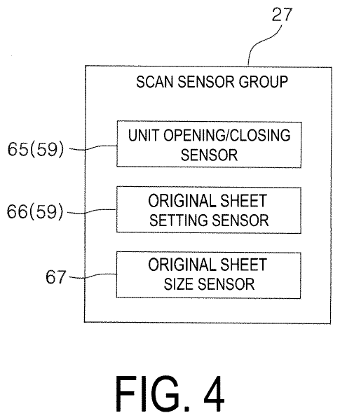

Next, the scanner unit 12 includes a scan sensor group 27 (see FIG. 2). As illustrated in FIG. 4, the scan sensor group 27 includes a unit opening/closing sensor 65, an original sheet setting sensor 66, and an original sheet size sensor 67. The unit opening/closing sensor 65 detects an opening/closing state of the automatic original sheet transport unit 12b. The control unit 20 can detect whether the unit opening/closing sensor 65 is opened or closed, based on the detection information from the unit opening/closing sensor 65. The original sheet setting sensor 66 detects that an original sheet is set on the original sheet tray 12c. The control unit 20 can detect that an original sheet is set on the original sheet tray 12c, based on the detection information from the original sheet setting sensor 66.

The original sheet size sensor 67 detects a size of an original sheet that is set on the original sheet tray 12c. The control unit 20 can detect a size of an original sheet that is set on the original sheet tray 12c, based on the detection information from the original sheet size sensor 67. Note that the scan sensor group 27 may include other sensors other than those sensors, or one or more of the sensors illustrated in FIG. 4 may not be included. Note that, in the scan sensor group 27, the unit opening/closing sensor 65 and the original sheet setting sensor 66 are examples of the detection means 59 for detecting an apparatus state change.

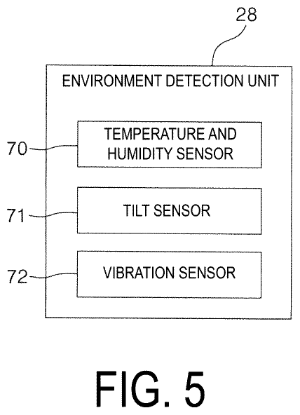

Next, the printing apparatus 1 includes an environment detection unit 28 (see FIG. 2) that detects an apparatus installation environment. As illustrated in FIG. 5, the environment detection unit 28 detects a temperature and humidity sensor 70, a tilt sensor 71, and a vibration sensor 72. As an example, the temperature and humidity sensor 70 is provided outside of the casing of the printing apparatus 1. The control unit 20 can grasp a temperature and a humidity in an installation environment of the printing apparatus 1, based on the detection information from the temperature and humidity sensor 70, and can feedback the temperature and the humidity to adjust a drying time after printing, for example. The tilt sensor 71 detects tilt of the printing apparatus 1 in an installation state. The control unit 20 can detect an installation angle of the printing apparatus 1, in particular, deviation from the horizontal direction, based on the detection information from the tilt sensor 71. With this, when an installation angle of the printing apparatus 1 is not appropriate, the control unit 20 can issue a warning regarding the inappropriate installation angle. The vibration sensor 72 detects vibration of the printing apparatus 1 in an installation state. The control unit 20 can detect vibration and shaking of the printing apparatus 1, based on the detection information from the vibration sensor 72. Note that the environment detection unit 28 may include other sensors other than those sensors, or one or more of the sensors illustrated in FIG. 5 may not be included.

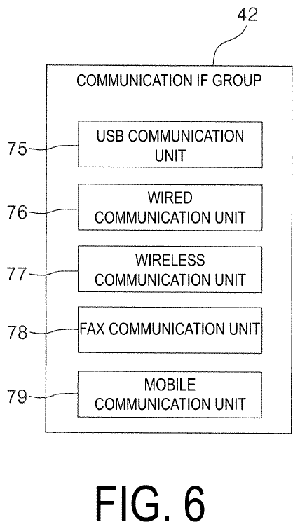

Next, as illustrated in FIG. 6, the communication IF group 42 (see FIG. 2) includes a USB communication unit 75, a wired communication unit 76, a wireless communication unit 77, a FAX communication unit 78, and a mobile communication unit 79. The USB communication unit 75 functions as a host that controls a USB device coupled to the printing apparatus 1. The wired communication unit 76 is a module that performs communication when the printing apparatus 1 is connected to a network such as a local area network in a wired manner. The wireless communication unit 77 is a module that performs communication when the printing apparatus 1 is connected to a network such as a local area network in a wireless manner. The FAX communication unit 78 is a module that performs facsimile communication when the printing apparatus 1 is connected to a communication line. The mobile communication unit 79 is a communication module for receiving an area mail such as an earthquake early warning. Note that the communication IF group 42 may include other communication units other than those communication units, or one or more of the communication units illustrated in FIG. 6 may not be included.

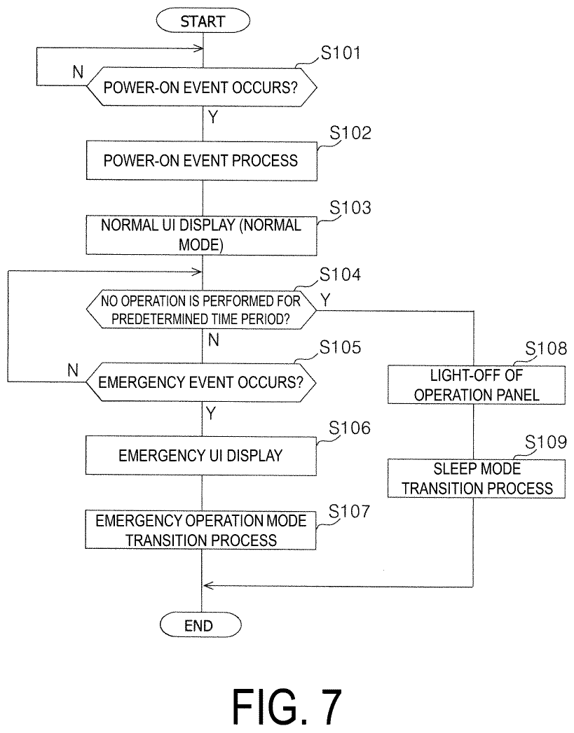

The configuration of the printing apparatus 1 is described above. An example of an operation mode switching process is described below with reference to FIG. 7. The printing apparatus 1 can be switched between the normal mode, an emergency operation mode, and a sleep mode as apparatus states controlled by the control unit 20. The normal mode is an example of a first operation mode, and the emergency operation mode is an example of a second operation mode. Note that the names of the normal mode and the emergency operation mode are examples. In particular, the emergency operation mode may be replaced with other names such as a disaster occurrence mode and a power saving operation mode. The normal mode and the emergency operation mode are modes in which power required for printing by the line head 18 is supplied. As a matter of course, power required for printing includes power required for feeding, transporting, and discharging a medium. The sleep mode is a mode in which power required for printing by the line head 18 is not supplied. The sleep mode may be replaced with names such as a stand-by mode and a power saving mode.

In the normal mode, power required for the respective units of the printing apparatus 1 is supplied, and all the functions of the printing apparatus 1 are operated normally. In the emergency operation mode, at least printing by the line head 18 can be performed while power supply to the respective units of the printing apparatus 1 is limited as compared to the normal mode. The sleep mode is a state in which power is supplied to some sensors, specifically, the detection means 59 for detecting an apparatus state change, which is described above, the LCD 3 of the operation panel 2, and the control unit 20 while power is not supplied to the other components. In the sleep mode, power is not supplied to the LED 4 of the operation panel 2, and light-off of the operation panel 2 is executed. In the emergency operation mode, power is supplied to the LED 4 of the operation panel 2 according to a condition, and light-on of the operation panel 2 is executed. Power consumption in the emergency operation mode is less than that in the normal mode, and is more than that in the sleep mode.

It is assumed that, in Step S101 in FIG. 7, the printing apparatus 1 is in the sleep mode. Further, it is assumed that the printing apparatus 1 is in the normal mode before transition to the sleep mode. In this state, when a power-on event occurs (Yes in Step S101), the control unit 20 executes a power-on process (Step S102). In other words, power is supplied to the components to which power is not supplied in the sleep mode, and the sleep mode is canceled. Note that examples of the power-on event include a signal change in the detection means 59 for detecting an apparatus state change, which is described above, touch of a hand or a finger of a user onto the LCD 3, reception of printing data from the outside, and the like. Then, the control unit 20 sets the operation panel 2 to normal UI display (Step S103). With this, the printing apparatus 1 is in the normal mode. Note that, when the printing apparatus 1 is not in the normal mode but in the emergency operation mode in Step S101, the printing apparatus 1 returns to the emergency operation mode in Step S103.

Next, when the printing apparatus 1 is in a non-operation state for a predetermined time period (Yes in Step S104), the control unit 20 executes light-off of the operation panel 2 (Step S108), and executes a transition process to the sleep mode (Step S109). Note that the non-operation state is a state in which a user does not touch the printing apparatus 1, and printing data is not received from the outside. When the non-operation state does not last the predetermined time period (No in Step S104), and an emergency event does not occur (No in Step S105), the control unit 20 maintains the normal mode.

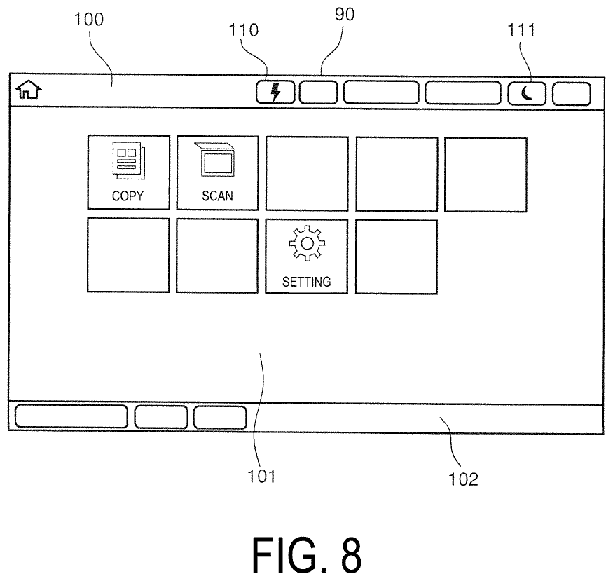

When the emergency event occurs (Yes in Step S105), the control unit 20 sets the UI of the operation panel 2 to an emergency UI (Step S106), and executes a transition process to the emergency operation mode (Step S107). Examples of the emergency event includes tapping on an emergency operation mode transition button (see FIG. 8) by a user, and other examples are described later.

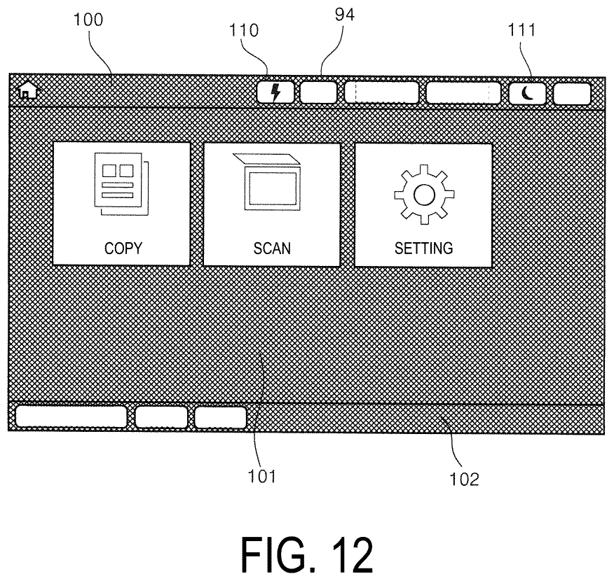

A UI 90 in FIG. 8 is a home screen in the normal mode, and the UI 90 includes a header area 100 at the top, a footer area 102 at the bottom, and a main area 101 at the center. Note that the respective UIs illustrated FIG. 8 and the following drawings only show display, buttons, and the like that are required for the description, and other elements are omitted. Further, the respective UIs illustrated FIG. 8 and the following drawings are displayed in color, except for the UI 94 illustrated in FIG. 12.

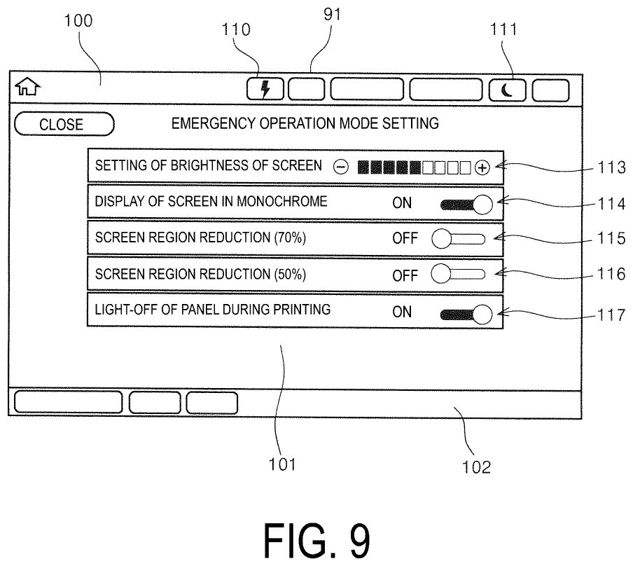

In the header area 100, an emergency operation mode transition button 110 and a sleep mode transition button 111 are arranged. When the emergency operation mode transition button 110 is tapped, transition to the emergency operation mode is executed. Further, when the sleep mode transition button 111 is tapped, transition to the sleep mode is executed. Note that, when the emergency operation mode transition button 110 is tapped after transition to the emergency operation mode is executed, the mode returns to the normal mode. Buttons, such as a copy button and a scan button, for using the functions of the printing apparatus 1 are arranged in the main area 101, and a setting button for executing various settings is also arranged. When the setting button is tapped, transition to a setting UI (omitted in illustration) for executing various settings of the printing apparatus 1 is executed. An emergency operation mode setting button (omitted in illustration) is arranged in the setting UI (omitted in illustration). When the emergency operation mode setting button is tapped, transition to the UI 91 illustrated in FIG. 9 is executed. Note that the setting button in FIG. 8 may be the emergency operation mode setting button.

The UI 91 illustrated in FIG. 9 is a setting screen in the emergency operation mode, in other words, a setting screen for a method of setting power consumption. The contents that are set on the screen are executed in the emergency operation mode. The reference 113 denotes a stepper for setting brightness of the screen. Further, the reference 114 denotes a toggle switch for setting whether to set the screen to a monochrome mode. Further, the references 115 and 116 denote toggle switches for setting reduction of the screen region. Note that, when one of the toggle switches 115 and 116 is set to an on state, the other one is grayed out, and cannot be set. Further, the reference 117 denotes a toggle switch for setting whether to execute light-off of the operation panel 2 during printing.

When the toggle switch 114 is set to an on state, the operation panel 2 is displayed in monochrome. With this, power consumption can be reduced as compared to color display. Further, when any one of the toggle switches 115 and 116 is set to an on state, the screen region is reduced at the set reduction rate, and power consumption can be reduced.

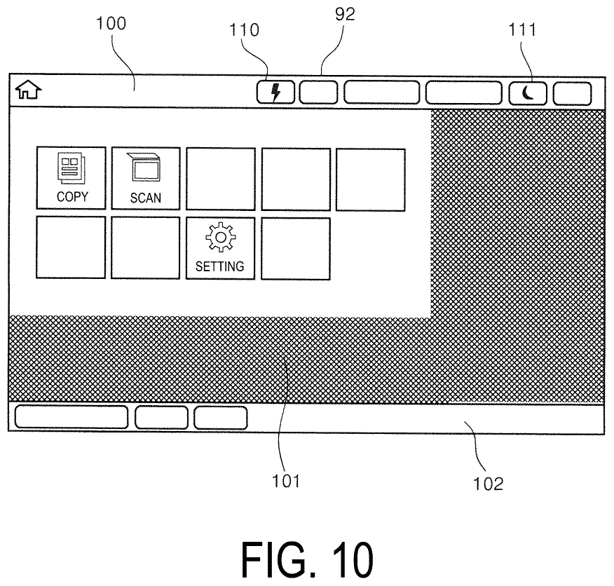

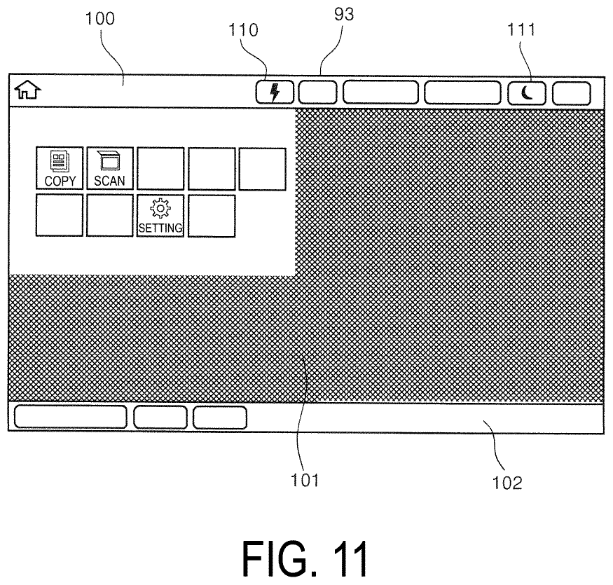

The UI 92 in FIG. 10 is a home screen when the toggle switch 115 is set to an on state and the reduction rate is set to 70%. In the embodiment, the main area 101 is displayed in a reduced size, and the hatched region is a light-off region. However, the header area 100 and the footer area 102 as a whole may be displayed in a reduced size. Further, the UI 93 in FIG. 11 is a home screen when the toggle switch 116 is set to an on state and the reduction rate is set to 50%. Note that, as a matter of course, the reduction rate may be other appropriate values.

Further, when the toggle switch 117 is set to an on state, light-on of the operation panel 2 is performed until a printing execution button (omitted in illustration) is tapped. When the printing execution button (omitted in illustration) is tapped, light-off is performed thereafter, and power consumption can be reduced. Note that, in this case, when the printing execution button (omitted in illustration) is tapped, a message “The screen is turned off to save electricity. Printing will continue.” or the like may be displayed for a predetermined time period, for example, approximately for one to three seconds, as an example. Note that, in the present embodiment, when the toggle switch 117 is set to an on state, light-off of the screen is performed regardless of the setting state of the stepper 113. When the toggle switch 117 is set to an off state, brightness of the screen is set based on the setting of the stepper 113. Further, when brightness of the screen is set to the minimum brightness, including at least during printing execution, power consumption can be reduced more. Note that, when the toggle switch 117 is set to an on state, brightness of the screen during light-on may be based on the setting of the stepper 113. In this case, when brightness of the screen is set to the minimum brightness, power consumption can be reduced more. Note that the toggle switches 114, 117, and any one of the toggle switches 115 and 116 can be set collectively to an on state.

Further, the UI 94 in FIG. 12 is an example in which the toggle switch 114 is set to an on state and the screen is in monochrome, and corresponds to a home screen obtained by displaying the home screen in FIG. 8 in monochrome. Light reduction or light-off of the LED 4 is performed on the UI 94 in FIG. 12 as compared to the home screen illustrated in FIG. 8. The number of operation icons is reduced as compared to the home screen illustrated in FIG. 8, and icons that are frequently used are displayed. With this, power consumption can be reduced.

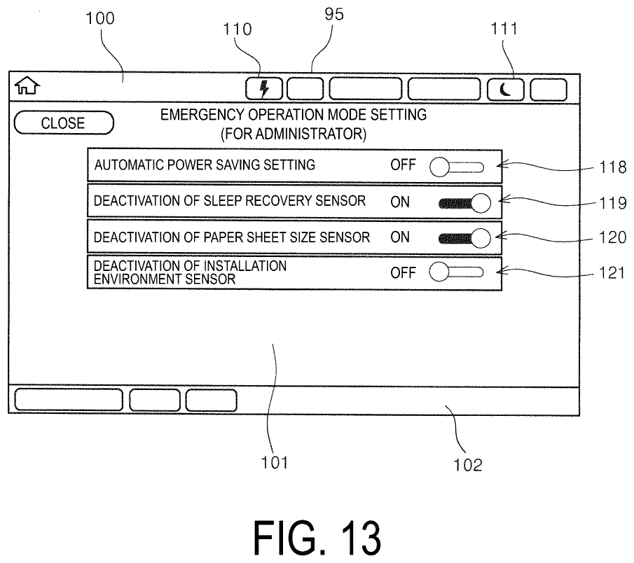

Further, the UI 95 in FIG. 13 is a setting screen in the emergency operation mode in an administrator mode. The administrator mode is a mode that can be accessed by tapping an administrator mode transition button (omitted in illustration) and verifying the administrator authority by an input of a password or the like. In the administrator mode, when the emergency operation mode setting button (omitted in illustration) is tapped, transition to the UI 95 in FIG. 13 is executed. Note that the UI 95 may be accessed by a general user. The reference 118 denotes a toggle switch for setting automatic power saving. When the toggle switch is set to an on state, the toggle switches 119, 120, and 121 are grayed out, and cannot be set. As an example, when the toggle switch 118 is set to an on state, a state in which all the toggle switches 119, 120, and 121 are set to an on state is achieved.

Further, the reference 119 denotes a toggle switch for setting deactivation of a sleep recovery sensor. When the toggle switch 119 is set to an on state, power is not supplied to the detection means 59 for detecting an apparatus state change, which is described above, and power consumption can be reduced. Further, the reference 120 denotes a toggle switch for setting deactivation of a paper sheet size sensor. When the toggle switch 120 is set to an on state, power is not supplied to the medium size sensor 63 (see FIG. 3) and the original sheet size sensor 67 (see FIG. 4) described above, and power consumption can be reduced. Further, the reference 121 denotes a toggle switch for setting deactivation of an installation environment sensor. When the toggle switch 121 is set to an on state, power is supplied to the environment detection unit 28 described above (see FIG. 5), and power consumption can be reduced.

As described above, the printing apparatus 1 includes the normal mode and the emergency operation mode being modes in which power required for printing by the line head 18 is supplied and the sleep mode being a mode power required for printing by the line head 18 is not supplied, as the apparatus states that are set by the control unit 20. Power consumption in the emergency operation mode is less than that in the normal mode, and is more than that in the sleep mode. Further, in the emergency operation mode, the method of setting power consumption can be customized via the UI 91 (see FIG. 9) or the UI 95 (see FIG. 13). With this, printing can be performed according to a user need while suppressing power consumption, and usability is improved.

Further, for example, in the event of a disaster, a commercial power source may be unusable, and a small power generator or a portable battery is required. In some cases, sufficient power cannot be obtained. Furthermore, even in such a case, there may be a need to utilize the printing function as much as possible for information transmission, in other words, a need to achieve a balance between reducing power consumption and ensuring the printing function. For example, according to the printing apparatus 1 in the emergency operation mode, power consumption can be reduced while performing color printing. In other words, a balance between reducing power consumption and ensuring the printing function can be achieved.

Further, in the present embodiment, monochrome display can be selected via the UI 91 (see FIG. 9) as a display mode of the operation panel 2 in the emergency operation mode. With this, power consumption in the emergency operation mode can be reduced.

Further, in the present embodiment, reduction of the display region can be selected via the UI 91 (see FIG. 9) as a display mode of the operation panel 2 in the emergency operation mode. With this, power consumption in the emergency operation mode can be reduced.

Further, in the present embodiment, light-off of the operation panel 2 at least during printing execution can be selected via the UI 91 (see FIG. 9) as a display mode of the operation panel 2 in the emergency operation mode. With this, power consumption in the emergency operation mode can be reduced.

Further, in the present embodiment, when a signal change in the detection means 59 for detecting an apparatus state change, which is described above, occurs in the sleep mode, the control unit 20 cancels the sleep mode (Step S101 in FIG. 7). Further, in the present embodiment, cutting-off of power supply to the detection means 59 in the emergency operation mode can be selected via the UI 95 (see FIG. 13). With this, power consumption in the emergency operation mode can be reduced. Note that there may be provided a UI (omitted in illustration) so that a sensor to which power is not supplied can be selected freely from the plurality of sensors forming the detection means 59, and power supply to the sensor can be cut off based on the UI.

Further, in the present embodiment, cutting-off of power supply to the medium size detection unit, in other words, the medium size sensor 63 and the original sheet size sensor 67 in the emergency operation mode can be selected via the UI 95 (see FIG. 13). With this, power consumption in the emergency operation mode can be reduced. Note that there may be provided a UI (omitted in illustration) so that a sensor to which power is not supplied can be selected freely from the medium size sensor 63 and the original sheet size sensor 67, and power supply to the sensor can be cut off based on the UI.

Further, in the present embodiment, cutting-off of power supply to the environment detection unit 28 in the emergency operation mode can be selected via the UI 95 (see FIG. 13). With this, power consumption in the emergency operation mode can be reduced. Note that there may be provided a UI (omitted in illustration) so that a sensor to which power is not supplied can be selected freely from the plurality of sensors forming the environment detection unit 28, and power supply to the sensor can be cut off based on the UI.

Further, a toggle switch (omitted in illustration) that can cut off power supply to the communication IF group 42 (see FIG. 6) may be added to the UI 95 illustrated in FIG. 13. In such a case, there may be provided a UI (omitted in illustration) so that a communication IF to which power is not supplied can be selected freely from the plurality of communication IFs forming the communication IF group 42, and power supply to the communication IF can be cut off based on the UI. Further, a toggle switch (omitted in illustration) that can cut off power supply to the entire scanner unit 12, the automatic original sheet transport unit 12b forming the scanner unit 12, or the like may be added to the UI 95 illustrated in FIG. 13. Further, when an optional device, for example, an additional medium cassette or the like is coupled to the printing apparatus 1, a toggle switch (omitted in illustration) that can cut off power supply to the optional device may be added to the UI 95 illustrated in FIG. 13.

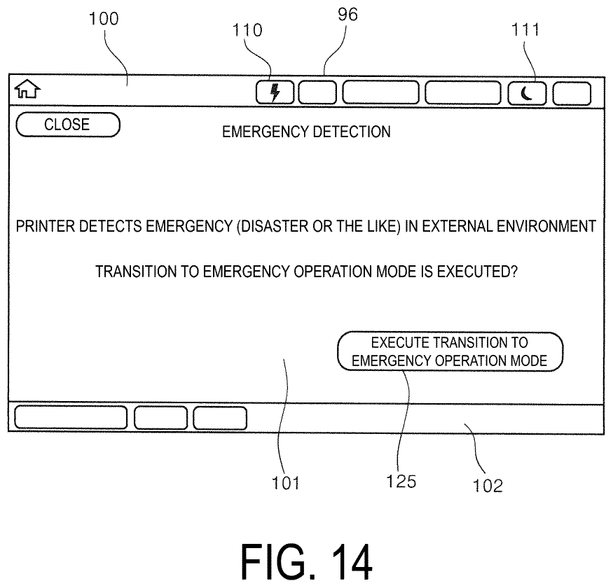

Further, in a modification example, transition to the emergency operation mode may be executed when the detection result from the environment detection unit 28 exceeds a predetermined range. For example, occurrence of an earthquake can be detected by the vibration sensor 72, and hence transition to the emergency operation mode may be executed when the detection result from the vibration sensor 72 exceeds a predetermined range. Further, in this state, transition to the emergency operation mode may be automatically executed. Alternatively, similarly to the UI 96 illustrated in FIG. 14, a message prompting a user for confirmation may be displayed. Then when the user taps on an emergency operation mode transition button 125, transition to the emergency operation mode may be executed.

Further, in a modification example, transition to the emergency operation mode may be executed when the control unit 20 receives an earthquake early warning. In such a case, transition to the emergency operation mode may be automatically executed. Alternatively, similarly to the UI 96 illustrated in FIG. 14, a message prompting a user for confirmation may be displayed. Then when the user taps on an emergency operation mode transition button 125, transition to the emergency operation mode may be executed. Further an external server may regularly acquire disaster information relating to the installation position of the printing apparatus 1. In the event of any disaster, transition to the emergency operation mode may be executed similarly to the description given above.

Note that setting of the emergency operation mode described above is executed via the operation panel 2 provided to the printing apparatus 1, which is not limited thereto. For example, setting may be executed via a printer driver running on an external computer that can access the printing apparatus 1. Further, the present disclosure is not limited to the embodiments and modifications described above, and it is obvious that various modifications are possible within the scope of the disclosure described in the claims, and these are also included in the scope of the present disclosure.

What is claimed is:

1. A printing apparatus comprising:
a printing unit configured to perform printing on a medium; and
a control unit configured to control the printing unit, wherein
apparatus states set by the control unit include:
a first operation mode and a second operation mode being modes where power required for printing by the printing unit is supplied; and
a sleep mode being a mode where power required for printing by the printing unit is not supplied,
power consumption in the second operation mode is less than that in the first operation mode, and is more than that in the sleep mode, and
the second operation mode is configured so that a method of setting power consumption is customized via a user interface.

2. A printing apparatus according to claim 1, comprising:
a display unit configured to display various information, wherein
monochrome display is selectable via the user interface as a display mode of the display unit in the second operation mode.

3. A printing apparatus according to claim 1, comprising:
a display unit configured to display various information, wherein
reduction of a display region is selectable via the user interface as a display mode of the display unit in the second operation mode.

4. A printing apparatus according to claim 1, comprising:
a display unit configured to display various information, wherein
minimum brightness of the display unit at least during printing execution is selectable via the user interface as a display mode of the display unit in the second operation mode.

5. A printing apparatus according to claim 1, comprising:
a display unit configured to display various information, wherein
light-off of the display unit at least during printing execution is selectable via the user interface as a display mode of the display unit in the second operation mode.

6. A printing apparatus according to claim 1, comprising:
a detection unit that detects an apparatus state change, wherein
the control unit cancels the sleep mode when a signal of the detection unit is changed in the sleep mode, and
cutting-off of power supply to the detection unit in the second operation mode is selectable via the user interface.

7. A printing apparatus according to claim 1, comprising:
a medium placement unit on which a medium before feeding is placed; and
a medium size detection unit configured to detect a size of the medium placed on the medium placement unit, wherein
cutting-off of power supply to the medium size detection unit in the second operation mode is selectable via the user interface.

8. A printing apparatus according to claim 1, comprising:
an environment detection unit configured to detect an apparatus installation environment, wherein
cutting-off of power supply to the environment detection unit in the second operation mode is selectable via the user interface.

9. A printing apparatus according to claim 1, comprising:
an environment detection unit configured to detect an apparatus installation environment, wherein
the control unit executes transition to the second operation mode when a detection result of the environment detection unit exceeds a predetermined range.

10. A printing apparatus according to claim 1, wherein
the control unit is configured to receive an earthquake early warning and execute transition to the second operation mode when the earthquake early warning is received.
